(19) United States
(12) Patent Application Publication
(10) Pub. No.: US 2024/0307790 A1
(43) Pub. Date: Sep. 19, 2024

(54) INFORMATION SENDING METHOD, INFORMATION SENDING APPARATUS, COMPUTER READABLE STORAGE MEDIUM, AND DEVICE

(71) Applicant: NETEASE (HANGZHOU) NETWORK CO., LTD., Hangzhou, Zhejiang (CN)

(72) Inventor: Xiaoxue HAN, Hangzhou, Zhejiang (CN)

(73) Assignee: NETEASE (HANGZHOU) NETWORK CO., LTD., Hangzhou, Zhejiang (CN)

(21) Appl. No.: 18/549,598

(22) PCT Filed: Feb. 25, 2022
(86) PCT No.: PCT/CN2022/078067

§ 371 Date: Sep. 8, 2023

(30) Foreign Application Priority Data
Jun. 25, 2021 (CN) 202110711165.X

(51) Int. Cl. A63F 13/87; A63F 13/42; A63F 13/533; A63F 13/837

(52) U.S. Cl. CPC A63F 13/87; A63F 13/42; A63F 13/533; A63F 13/837; A63F 2300/308

(57) ABSTRACT

An information sending method, a computer readable storage medium, and an electronic device are provided. The method includes: in response to a first touch operation acting on a preset control, determining that an interface focus of a game visual field picture corresponds to a second virtual object of a game scene, and displaying a first option set corresponding to the second virtual object, wherein the second virtual object is any virtual object, belonging to the same game side as a first virtual object, in a virtual object set; in response to a second touch operation acting on a first target option in the first option set, determining prompt information corresponding to the first target option; and directionally sending the prompt information corresponding to the first target option to a user terminal corresponding to the second virtual object.

### CROSS-REFERENCE TO RELATED APPLICATION

The present disclosure claims priority to Chinese Patent Application No. 202110711165.X, filed Jun. 25, 2021, titled “INFORMATION SENDING METHOD, INFORMATION SENDING APPARATUS, COMPUTER READABLE MEDIUM, AND DEVICE”, the entire content of which is incorporated herein by reference.

### TECHNICAL FIELD

The present disclosure relates to the technical field of interface interaction, and in particular, to an information sending method, an information sending apparatus, a computer-readable medium, and an electronic device.

### BACKGROUND

In games that require players to fight together, players in the same team may usually communicate through the chat window, and players may arrange tactics in the same chat window according to the current game situation, so as to win the game through teamwork. However, when a player needs to send a message point-to-point, it is necessary to add the name of the to-be-sent object before the content of the message, so that the to-be-sent object can know that the message sent in the chat window is specially sent to him/her. Such communication method usually has a problem of low efficiency.

It should be noted that the information disclosed in the above background section is only for enhancing the understanding of the background of the present disclosure, and therefore may include information that does not constitute the prior art known to those of ordinary skill in the art.

### SUMMARY

The purpose of the embodiments of the present disclosure is to provide an information sending method, an information sending apparatus, a computer-readable medium, and an electronic device, which can realize directional sending of information, so that it is convenient for players to send information point-to-point in the process of teamwork, and to improve team communication efficiency.

The first aspect of the embodiments of the present disclosure provides an information sending method, a graphical user interface is provided through a terminal device, the graphical user interface includes a game visual field screen, and the game visual field screen includes at least part of a game scene and at least part of a first virtual object located in the game scene. The method includes:

in response to a first touch operation acting on a preset control, determining that an interface focus of the game visual field screen corresponds to a second virtual object of the game scene, and displaying a first set of options corresponding to the second virtual object, where the first set of options includes at least one option; where the second virtual object is any virtual object in a virtual object set belonging to a same game side as the first virtual object;

in response to a second touch operation acting on a first target option in the first set of options, determining prompt information corresponding to the first target option, where the first target option is an option in at least one option; and
directionally sending the prompt information corresponding to the first target option to a user terminal corresponding to the second virtual object.

In an exemplary embodiment of the present disclosure, the above method further includes:
in response to a visual field adjustment instruction, controlling the game visual field screen to be adjusted from a first game visual field screen to a second game visual field screen according to the visual field adjustment instruction;
in response to a third touch operation acting on the preset control, determining that the interface focus of the game visual field screen corresponds to a target object of the game scene, and displaying a second set of options corresponding to the target object, where the target object includes at least one of: a virtual resource and a virtual scene;
in response to a fourth touch operation acting on a second target option in the second set of options, determining prompt information corresponding to the second target option; and
directionally sending the prompt information corresponding to the second target option to a user terminal corresponding to the target object.

In an exemplary embodiment of the present disclosure, in a case that the target object is the virtual scene, the displaying the second set of options corresponding to the target object includes:
displaying a set of content options in the second set of options corresponding to the target object, where the set of content options is a combination of different information that needs to be conveyed to a target second virtual object;
in response to a fourth touch operation acting on a second target option in the second set of options, determining prompt information corresponding to the second target option includes:

in response to a first sub-operation of the fourth touch operation, determining a target content option from the set of content options;
in response to determining the target content option, triggering display of a set of second virtual object identifiers in the second set of options;
in response to a second sub-operation of the fourth touch operation, determining a target object identifier from the set of virtual object identifiers;
determining corresponding prompt information according to the target object identifier and the target content option.

In an exemplary embodiment of the present disclosure, in a case that the target object is the virtual resource, the displaying the second set of options corresponding to the target object includes:
displaying a set of virtual object identifiers; and
in response to the fourth touch operation acting on the second target option in the second set of options, determining the prompt information corresponding to the second target option, includes:

in response to the fourth touch operation, determining a target object identifier from the set of virtual object identifiers;
determining corresponding prompt information according to the target object identifier and the target object.

In an exemplary embodiment of the present disclosure, the second set of options includes a set of virtual object identifiers, and in response to the fourth touch operation acting on the second target option in the second set of options, includes:
in response to the fourth touch operation acting on the second target option in the second set of options, determining a target object identifier from the set of virtual object identifiers according to a position of the fourth touch operation; and
the directionally sending the prompt information corresponding to the second target option to the user terminal corresponding to the target object includes:
directionally sending the prompt information corresponding to the second target option to a second terminal device corresponding to the target object identifier.

In an exemplary embodiment of the present disclosure, the second set of options and the first set of options are represented as circular icons arranged with a specific position as a center.

According to the second aspect of the embodiments of the present disclosure, an information sending method is provided, where a graphical user interface is provided through a terminal device, and the graphical user interface includes a game visual field screen. The method includes:
in response to a first touch operation acting on a preset control, determining that an interface focus of the game visual field screen corresponds to a target object of the game scene, and displaying a first set of options corresponding to the target object, where the first set of options includes at least one option; where the target object includes at least one of a virtual resource or a virtual scene;
in response to a second touch operation acting on a first target option in the first set of options, determining prompt information corresponding to the first target option, where the first target option is an option in at least one option; and
directionally sending the prompt information corresponding to the first target option to a user terminal corresponding to the target object.

According to a third aspect of the embodiments of the present disclosure, an information sending apparatus is provided, and the above apparatus includes:
an option set output unit, configured to, in response to a first touch operation acting on a preset control, determine that an interface focus of the game visual field screen corresponds to a second virtual object in the game scene, and display a first set of options corresponding to the second virtual object, where the first set of options includes at least one option; where the second virtual object is any virtual object in a virtual object set belonging to a same game side as the first virtual object;
a prompt information determining unit, configured to, in response to a second touch operation acting on a first target option in the first set of options, determine prompt information corresponding to the first target option, where the first target option is an option in the at least one of the option; and
an information directional sending unit, configured to directionally send the prompt information corresponding to the first target option to a user terminal corresponding to the second virtual object.

In an exemplary embodiment of the present disclosure, the above-mentioned apparatus further includes:
a visual field screen adjustment unit, configured to, in response to a visual field adjustment instruction, control the game visual field screen to be adjusted from a first game visual field screen to a second game visual field screen according to the visual field adjustment instruction;
an option set output unit, configured to, in response to a third touch operation acting on the preset control, determine that the interface focus of the game visual field screen corresponds to a target object of the game scene, and display a second set of options corresponding to the target object, where the target object includes at least one of a virtual resource or a virtual scene;
a prompt information determining unit, configured to, in response to a fourth touch operation acting on a second target option in the second set of options, determine prompt information corresponding to the second target option;
an information directional sending unit, configured to directionally send the prompt information corresponding to the second target option to a user terminal corresponding to the target object.

In an exemplary embodiment of the present disclosure, in a case that the target object is the virtual scene, the option set output unit displaying the second set of options corresponding to the target object includes:
displaying a set of content options in the second set of options corresponding to the target object, where the set of content options is a combination of different information that needs to be conveyed to a target second virtual object;
the prompt information determining unit determining the prompt information corresponding to the second target option in response to the fourth touch operation acting on the second target option in the second set of options, includes:

in response to a first sub-operation of the fourth touch operation, determining a target content option from the set of content options;
in response to determining the target content option, triggering display of a set of second virtual object identifiers in the second set of options;
in response to a second sub-operation of the fourth touch operation, determining a target object identifier from the set of virtual object identifiers;
determining corresponding prompt information according to the target object identifier and the target content option.

In an exemplary embodiment of the present disclosure, in a case that the target object is the virtual resource, the option set output unit displaying the second set of options corresponding to the target object, includes:
displaying a set of virtual object identifiers;
the prompt information determining unit determining the prompt information corresponding to the second target option in response to the fourth touch operation acting on the second target option in the second set of options, includes:
in response to the fourth touch operation, determining a target object identifier from the set of virtual object identifiers;
determining corresponding prompt information according to the target object identifier and the target object.

In an exemplary embodiment of the present disclosure, the second set of options includes a set of virtual object identifiers, and the prompt information determining unit responding to the fourth touch operation acting on the second target option in the second set of options, includes:
in response to the fourth touch operation acting on the second target option in the second set of options, determining a target object identifier from the set of virtual object identifiers according to a position of the fourth touch operation; and
the information directional sending unit sending the prompt information corresponding to the second target option to the user terminal corresponding to the target object, includes:
directionally sending the prompt information corresponding to the second target option to a second terminal device corresponding to the target object identifier.

In an exemplary embodiment of the present disclosure, the second set of options and the first set of options are represented as circular icons arranged with a specific position as a center.

According to the fourth aspect of the embodiments of the present disclosure, an information sending apparatus is provided, where a graphical user interface is provided through a terminal device, and the graphical user interface includes a game visual field screen. The apparatus includes:
an option set output unit, configured to, in response to a first touch operation acting on a preset control, determine that an interface focus of the game visual field screen corresponds to a target object of the game scene, and display a first set of options corresponding to the target object, where the first set of options includes at least one option; where the target object includes at least one of a virtual resource or a virtual scene;
a prompt information determining unit, configured to, in response to a second touch operation acting on a first target option in the first set of options, determine prompt information corresponding to the first target option, where the first target option is an option in the at least one options; and
an information directional sending unit, configured to directionally send the prompt information corresponding to the first target option to a user terminal corresponding to the target object.

According to a fifth aspect of the embodiments of the present disclosure, there is provided a computer-readable medium on which a computer program is stored, and when the program is executed by a processor, the information sending method in the first aspect of the above-mentioned embodiments is implemented.

According to a sixth aspect of the embodiments of the present disclosure, there is provided an electronic device, including: one or more processors; a storage apparatus for storing one or more programs, where when one or more programs are executed by one or more processors, one or more processors are enabled to implement the information sending method of the first aspect in the foregoing embodiments.

According to a seventh aspect of the present disclosure, there is provided a computer program product or computer program including computer instructions stored in a computer readable storage medium. The processor of the computer device reads the computer instructions from the computer-readable storage medium, and the processor executes the computer instructions, so that the computer device executes the methods provided in the above-mentioned various optional implementation manners.

The technical solutions provided by the embodiments of the present disclosure may include the following beneficial effects.

The technical solutions provided in some embodiments of the present disclosure specifically includes: in response to the first touch operation acting on the preset control, determining that the interface focus of the game visual field screen corresponds to the second virtual object of the game scene, and displaying the first set of options corresponding to the second virtual object, where the first set of options includes at least one option; where the second virtual object is any virtual object in the virtual object set belonging to the same game side as the first virtual object; in response to the second touch operation acting on the first target option in the first set of options, determining the prompt information corresponding to the first target option, where the first target option is an option in at least one option; directionally sending the prompt information corresponding to the first target option to the user terminal corresponding to the second virtual object. On the other hand, the set of options may be output for the user to select, and the user only needs to select one option from the set of options to realize the directional information sending to the to-be-sent object without inputting text, which can further improve the communication efficiency.

It is to be understood that both the foregoing general description and the following detailed description are exemplary and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure. Apparently, the drawings in the following description are only some embodiments of the present disclosure, and those skilled in the art can obtain other drawings according to these drawings without creative efforts.

FIG. 1 schematically shows a schematic diagram of an exemplary system architecture in which an information sending method and an information sending apparatus according to an embodiment of the present disclosure can be applied;

FIG. 2 schematically shows a schematic structural diagram of a computer system suitable for implementing an electronic device according to an embodiment of the present disclosure;

FIG. 3 schematically shows a flowchart of an information sending method according to an embodiment of the present disclosure;

FIG. 4 schematically shows a schematic diagram of an interface including a first set of options according to an embodiment of the present disclosure;

FIG. 5 schematically shows a schematic diagram of an interface including a first set of options according to an embodiment of the present disclosure;

FIG. 6 schematically shows a schematic diagram of an interface including a second set of options according to an embodiment of the present disclosure;

FIG. 7 schematically shows a schematic diagram of a display interface including a second set of options according to an embodiment of the present disclosure;

FIG. 8 schematically shows a schematic diagram of an interface for displaying prompt information on a user terminal according to an embodiment of the present disclosure;

FIG. 9 schematically shows a flowchart of an information sending method according to an embodiment of the present disclosure;

FIG. 10 schematically shows a schematic diagram of a graphical user interface according to an embodiment of the present disclosure;

FIG. 11 schematically shows a structural block diagram of an information sending apparatus according to an embodiment of the present disclosure.

### DETAILED DESCRIPTION

Exemplary embodiments will now be described more fully with reference to the accompanying drawings. The exemplary embodiments may, however, be embodied in many forms and should not be construed as limited to the examples set forth herein; rather, these embodiments are provided so that the present disclosure will be thorough and complete and the concept of exemplary embodiments will be fully conveyed to those skilled in the art. The described features, structures, or characteristics may be combined in any suitable manner in one or more embodiments. In the following description, numerous specific details are provided in order to give a thorough understanding of the embodiments of the present disclosure. However, those skilled in the art will appreciate that the technical solutions of the present disclosure may be practiced without one or more of the specific details, or other methods, components, apparatuses, steps, etc. may be adopted. In other instances, well-known technical solutions are not shown or described in detail to avoid obscuring aspects of the present disclosure.

Furthermore, the drawings are merely schematic illustrations of the present disclosure and are not necessarily drawn to scale. The same reference numerals in the drawings denote the same or similar parts, and thus repeated descriptions thereof will be omitted. Some of the block diagrams shown in the drawings are functional entities and do not necessarily correspond to physically or logically independent entities. These functional entities may be implemented in software, or in one or more hardware modules or integrated circuits, or in different network and/or processor means and/or microcontroller means.

First, some nouns or terms appearing in the process of describing the embodiments of the present disclosure are explained:

### Virtual Scene

The virtual scene is a virtual scene displayed (or provided) by an application program when it is running on a terminal or server. Optionally, the virtual scene is a simulation environment of the real world, or a half-simulation and half-fictional virtual environment, or a purely fictional virtual environment. The virtual scene is any one of a two-dimensional virtual scene and a three-dimensional virtual scene, and the virtual environment may be sky, land, ocean, etc. The land includes environmental elements such as deserts and cities. The virtual scene is a scene in which the user controls the virtual object(s) to complete the game logic. For example, in a sandbox 3D shooting game, the virtual scene is a 3D game world for players to control the virtual objects to fight against. An exemplary virtual scene may include at least one element of mountains, plains, rivers, lakes, oceans, deserts, sky, plants, buildings, and vehicles. For example, for 2D card games, the virtual scene is a scene for displaying releasing of cards or displaying the virtual object corresponding to the card. The exemplary virtual scene may include: the arena, the battle field, or other “field” elements that can display the state of the card battle or other elements. For 2D or 3D multiplayer online tactical competitive games, the virtual scene is a 2D or 3D terrain scene for the virtual objects to fight against. The exemplary virtual scene may include: canyon-style mountains, lines, rivers, classrooms, tables and chairs, podiums and other elements.

### Virtual Object

The virtual object refers to a dynamic object that can be controlled in the virtual scene. Optionally, the dynamic object may be a virtual character, a virtual animal, an anime character, or the like. The virtual object is a character controlled by the player through an input device, or an artificial intelligence (AI) set in a virtual environment battle through training, or a non-player character (NPC) set in a virtual scene battle. Optionally, the virtual object is a virtual character competing in a virtual scene. Optionally, the number of virtual objects in the virtual scene battle is preset, or dynamically determined according to the number of clients joining the battle, which is not limited in the embodiments of the present disclosure. In a possible implementation manner, the user can control the virtual object to move in the virtual scene, for example, control the virtual object to run, jump, crawl, etc., and can also control the virtual object to use the skills, virtual props and the like provided by the application to fight with other virtual objects.

### Virtual Substance

The virtual substance refers to a static object in the virtual scene, such as terrain, houses, bridges, vegetation, etc. in the game scene. Usually, the static objects are not directly controlled by the player, but can respond to the interactive behavior of the virtual objects in the scene (such as attacking, demolishing, etc.), and make corresponding performances, for example: the virtual objects may demolish, pick up, drag, build the buildings. Optionally, the virtual object may also be unable to respond to the interactive behavior of the virtual object. For example, the virtual object may also be a building, door, window, plant, etc. in the game scene, but the virtual object cannot interact with it. For example, the virtual object cannot damage or remove the window.

### Virtual Resource

The virtual resource is a virtual prop (such as firearms, a protective clothing, a material, a building material, etc.), a virtual asset (such as a gold coin, a point), or a virtual object (such as a wild monster, a building, etc.) or the like that can help the virtual object to better complete the purpose of the game and is obtained in the complete feature game task of inside the game or outside the game. In an optional implementation manner, for example, in shooting games, the virtual resource may be firearms, ammunition, a protective clothing, firearm accessories, healing supplies, detachable houses, etc. In MOBA games, the virtual resource may refer to a wild monster virtual object with different attributes, etc.

### Virtual Prop

The virtual prop refers to a prop that the virtual object can use in the virtual environment, including but not limited to the virtual items that can be used by the virtual object so as to speed up its own attributes, assist fight or cause damage to other virtual objects, such as bullets firearms, cold weapons, grenades, shields, springboards, puppets, etc. The virtual prop may also be a supply prop such as a bullet, and may also be an accessory such as an expanded cartridge clip, a sight magnifier, a flame suppressor, and a gun butt that is assembled on a designated virtual weapon.

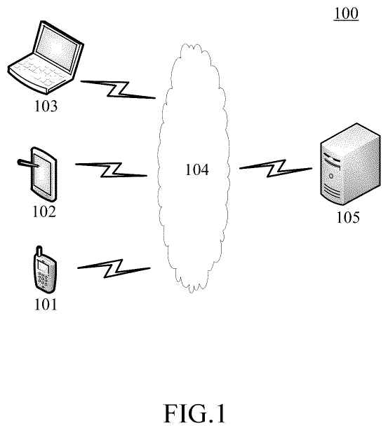

FIG. 1 shows a schematic diagram of a system architecture of an exemplary application environment in which an information sending method and an information sending apparatus according to an embodiment of the present disclosure can be applied.

As shown in FIG. 1, the system architecture 100 may include one or more of terminal devices 101, 102, 103, a network 104 and a server 105. The network 104 is used as a medium for providing communication links between the terminal devices 101, 102, 103 and the server 105. The network 104 may include various connection types, such as wires, wireless communication links, or fiber optic cables. The terminal devices 101, 102, and 103 may be various electronic devices with display screens, including but not limited to desktop computers, portable computers, smart phones, and tablet computers. It should be understood that the numbers of the terminal devices, the network and the server in FIG. 1 are only illustrative. According to the implementation needs, there may be any number of the terminal devices, the network and the server. For example, the server 105 may be a server cluster composed of a plurality of servers. The server 105 is configured to: in response to a first touch operation acting on a preset control, determine that an interface focus of a game visual field screen corresponds to a second virtual object of a game scene, and display a first set of options corresponding to the second virtual object, where the first set of options includes at least one option; where the second virtual object is any virtual object in a virtual object set belonging to the same game side as the first virtual object; in response to a second touch operation acting on a first target option in the first set of options, determine prompt information corresponding to the first target option, where the first target option is an option in at least one option; and send the prompt information corresponding to the first target option to a user terminal corresponding to the second virtual object.

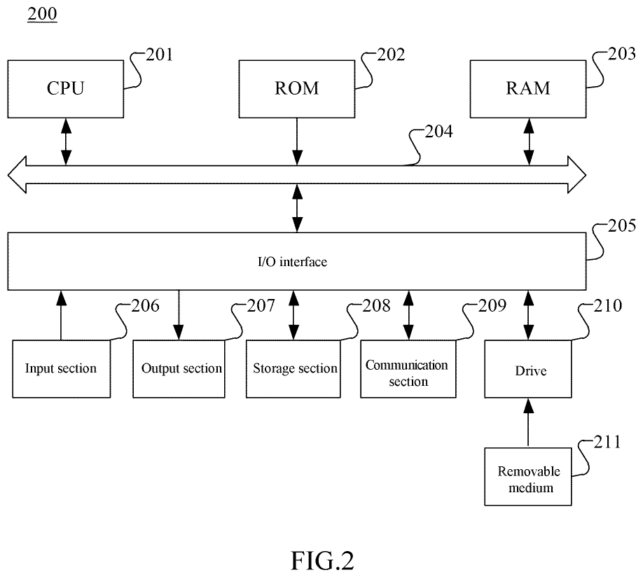

FIG. 2 shows a schematic structural diagram of a computer system suitable for implementing the electronic device of the embodiments of the present disclosure.

It should be noted that the computer system 200 of the electronic device shown in FIG. 2 is only an example, and should not limit the functions and application scope of the embodiments of the present disclosure.

As shown in FIG. 2, the computer system 200 includes a central processing unit (CPU) 201 that can perform various appropriate actions and processes according to a program stored in a read-only memory (ROM) 202 or a program loaded from a storage section 208 into a random-access memory (RAM) 203. In (RAM) 203, various programs and data necessary for system operation are also stored. (CPU) 201, (ROM) 202, and (RAM) 203 are connected to each other via a bus 204. An input/output (I/O) interface 205 is also connected to the bus 204.

The following components are connected to the (I/O) interface 205: an input section 206 including a keyboard, a mouse, etc.; an output section 207 including a cathode ray tube (CRT), a liquid crystal display (LCD), etc., and a speaker; a storage section 208 including a hard disk, etc.; and a communication section 209 including a network interface card such as a LAN card, a modem, or the like. The communication section 209 performs communication processing via a network such as the Internet. A drive 210 is also connected to the (I/O) interface 205 as needed. A removable medium 211, such as a magnetic disk, an optical disk, a magneto-optical disk, a semiconductor memory, etc., is mounted on the drive 210 as necessary so that a computer program read therefrom is installed into the storage section 208 as necessary.

In particular, according to an embodiment of the present disclosure, the processes described below with reference to the flowcharts can be implemented as computer software programs. For example, the embodiments of the present disclosure include a computer program product, which includes a computer program carried on a computer-readable medium, where the computer program includes program codes for executing the methods shown in the flowcharts. In such an embodiment, the computer program may be downloaded and installed from a network via the communication section 209 and/or installed from the removable media 211. When the computer program is executed by the central processing unit (CPU) 201, various functions defined in the method and apparatus of the present disclosure are performed.

It should be noted that the computer-readable medium shown in the present disclosure may be a computer-readable signal medium or a computer-readable storage medium or any combination of the above two. The computer readable storage medium may be, for example, but not limited to, an electrical, magnetic, optical, electromagnetic, infrared, or semiconductor system, apparatus, or device, or any combination thereof. More specific examples of the computer-readable storage media may include, but are not limited to, electrical connections with one or more wires, portable computer diskettes, hard disks, random access memory (RAM), read-only memory (ROM), erasable Programmable read-only memory (EPROM or flash memory), optical fiber, portable compact disk read-only memory (CD-ROM), optical storage device, magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal medium may include a data signal propagated in baseband or as part of a carrier, carrying the computer-readable program code therein. Such propagated data signal may take many forms, including but not limited to electromagnetic signals, optical signals, or any suitable combination of the above. The computer-readable signal medium may also be any computer-readable medium other than the computer-readable storage medium, and the computer-readable medium can send, propagate, or transmit a program for use by or in combination with an instruction execution system, apparatus, or device. The program code contained in the compute-readable medium may be transmitted using any appropriate medium, including but not limited to wireless, wire, optical cable, RF, etc., or any suitable combination of the foregoing.

The flowcharts and block diagrams in the drawings illustrate the architecture, functionality, and operation of possible implementations of systems, methods and computer program products according to various embodiments of the present disclosure. In this regard, each block in the flowcharts or block diagrams may represent one module, a program segment, or portion of code that includes one or more executable instructions for implementing specified logical functions. It should also be noted that, in some alternative implementations, the functions noted in the block may occur out of the order noted in the drawings. For example, two blocks shown in succession may, in fact, be executed substantially concurrently, or they may sometimes be executed in the reverse order, depending upon the functionality involved. It should also be noted that each block in the block diagrams or flowcharts, and combinations of blocks in the block diagrams or flowcharts, can be implemented by a dedicated hardware-based system that performs the specified function or operation, or can be implemented by a combination of dedicated hardware and computer instructions.

The units involved in the embodiments of the present disclosure may be implemented by software or by hardware, and the described units may also be set in a processor. The names of these units do not constitute a limitation of the unit itself under certain circumstances.

In another aspect, the present disclosure also provides an electronic device, which includes:

one or more memories; a storage apparatus; the storage apparatus is configured to store one or more programs, when the one or more programs are executed by one or more processors, one or more processors implement any one of the following information sending methods.

In an information sending method, a graphical user interface is provided through a terminal device, the graphical user interface includes a game visual field screen, and the game visual field screen includes at least part of a game scene and at least part of a first virtual object located in the game scene, the method includes:
in response to a first touch operation acting on a preset control, determining that an interface focus of the game visual field screen corresponds to a second virtual object of the game scene, and displaying a first set of options corresponding to the second virtual object, where the first set of options includes at least one option; where the second virtual object is any virtual object in a virtual object set belonging to a same game side as the first virtual object;
in response to a second touch operation acting on a first target option in the first set of options, determining prompt information corresponding to the first target option, where the first target option is an option in the at least one option;
directionally sending the prompt information corresponding to the first target option to a user terminal corresponding to the second virtual object.

The method further includes: in response to a visual field adjustment instruction, controlling the game visual field screen to be adjusted from a first game visual field screen to a second game visual field screen according to the visual field adjustment instruction;
in response to a third touch operation acting on the preset control, determining that the interface focus of the game visual field screen corresponds to a target object of the game scene and displaying a second set of options corresponding to the target object, the second set of options includes at least one option, where the target object includes at least one of a virtual resource or a virtual scene;
in response to a fourth touch operation acting on a second target option in the second set of options, determining prompt information corresponding to the second target option, where the second target option is an option in the at least one option;
directionally sending the prompt information corresponding to the second target option to a user terminal corresponding to the target object.

If the target object is a virtual scene, displaying a second set of options corresponding to the target object includes:
displaying a set of content options in the second set of options corresponding to the target object, the set of content options being a combination of different information that needs to be conveyed to a target second virtual object;
in response to the fourth touch operation acting on the second target option in the second set of options, determining the prompt information corresponding to the second target option includes:

in response to a first sub-operation of the fourth touch operation, determining a target content option from the set of content options;
in response to determining the target content option, triggering display of a set of second virtual object identifiers in the second set of options;
in response to a second sub-operation of the fourth touch operation, determining a target object identifier from the set of virtual object identifiers;
determining corresponding prompt information according to the target object identifier and the target content option.

If the target object is the virtual resource, displaying the second set of options corresponding to the target object includes:
displaying a set of virtual object identifiers;
in response to the fourth touch operation acting on the second target option in the second set of options, determining the prompt information corresponding to the second target option includes:

in response to the fourth touch operation, determining a target object identifier from the set of virtual object identifiers;
determining corresponding prompt information according to the target object identifier and the target object.

The second set of options includes a set of virtual object identifiers, and in response to the fourth touch operation acting on the second target option in the second set of options includes:
in response to the fourth touch operation acting on the second target option in the second set of options, determining a target object identifier from the set of virtual object identifiers according to a position of the fourth touch operation;
directionally sending the prompt information corresponding to the second target option to the user terminal corresponding to the target object includes:
directionally sending the prompt information corresponding to the second target option to a second terminal device corresponding to the target object identifier.

The second set of options and the first set of options are represented as circular icons arranged with a specific position as a center.

In another information sending method, a graphical user interface is provided through a terminal device, and the graphical user interface includes a game visual field screen, the method includes:
in response to a first touch operation acting on a preset control, determining that an interface focus of the game visual field screen corresponds to a target object of the game scene, and displaying a first set of options corresponding to the target object, where the first set of options includes at least one option; where the target object includes at least one of a virtual resource or a virtual scene;
in response to a second touch operation acting on a first target option in the first set of options, determining prompt information corresponding to the first target option, where the first target option is an option in the at least one option; and
directionally sending the prompt information corresponding to the first target option to a user terminal corresponding to the target object.

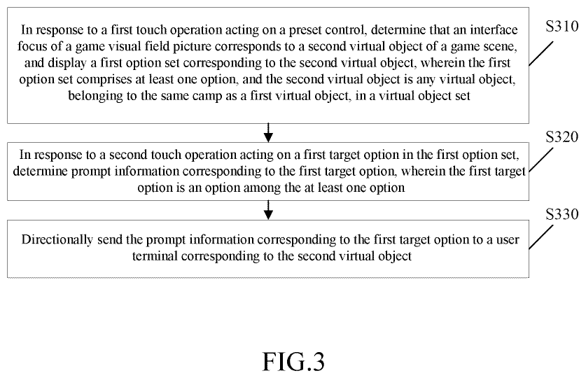

As another aspect, the present disclosure also provides a computer-readable medium. The computer-readable medium may be included in the electronic device described in the above-mentioned embodiments; or it may exist independently without being assembled into the electronic device. The above-mentioned computer-readable medium carries one or more programs, and when the above-mentioned one or more programs are executed by the electronic device, the electronic device is enabled to implement any one of the following information sending methods. For example, the electronic device can implement various steps as shown in FIG. 3.

In an information sending method, a graphical user interface is provided through a terminal device, the graphical user interface includes a game visual field screen, and the game visual field screen includes at least part of a game scene and at least part of a first virtual object located in the game scene, the method includes:
in response to a first touch operation acting on a preset control, determining that an interface focus of the game visual field screen corresponds to a second virtual object of the game scene, and displaying a first set of options corresponding to the second virtual object, where the first set of options includes at least one option; where the second virtual object is any virtual object in a virtual object set belonging to a same game side as the first virtual object;
in response to a second touch operation acting on a first target option in the first set of options, determining prompt information corresponding to the first target option, where the first target option is an option in the at least one option;
directionally sending the prompt information corresponding to the first target option to a user terminal corresponding to the second virtual object.

The method further includes:
in response to a visual field adjustment instruction, controlling the game visual field screen to be adjusted from a first game visual field screen to a second game visual field screen according to the visual field adjustment instruction;
in response to a third touch operation acting on the preset control, determining that the interface focus of the game visual field screen corresponds to a target object of the game scene and displaying a second set of options corresponding to the target object, where the second set of options includes at least one option, where the target object includes at least one of a virtual resource or a virtual scene;
in response to a fourth touch operation acting on a second target option in the second set of options, determining prompt information corresponding to the second target option, where the second target option is an option in the at least one option; and
directionally sending the prompt information corresponding to the second target option to the user terminal corresponding to the target object.

If the target object is a virtual scene, displaying the second set of options corresponding to the target object includes:
displaying a set of content options in the second set of options corresponding to the target object, the set of content options being a combination of different information that needs to be conveyed to the target second virtual object;
in response to the fourth touch operation acting on the second target option in the second set of options, determining prompt information corresponding to the second target option includes:
in response to a first sub-operation of the fourth touch operation, determining a target content option from the set of content options;
in response to determining the target content option, triggering display of a set of second virtual object identifiers in the second set of options;
in response to a second sub-operation of the fourth touch operation, determine a target object identifier from the set of virtual object identifiers;
determining corresponding prompt information according to the target object identifier and the target content option.

If the target object is a virtual resource, displaying the second set of options corresponding to the target object includes:
displaying a set of virtual object identifiers; and
in response to the fourth touch operation acting on the second target option in the second set of options, determining prompt information corresponding to the second target option includes:
in response to the fourth touch operation, determining a target object identifier from the set of virtual object identifiers;
determining corresponding prompt information according to the target object identifier and the target object.

The second set of options includes a set of virtual object identifiers, and in response to the fourth touch operation acting on the second target option in the second set of options includes:
in response to the fourth touch operation acting on the second target option in the second set of options, determining a target object identifier from the set of virtual object identifiers according to a position of the fourth touch operation; and
directionally sending the prompt information corresponding to the second target option to the user terminal corresponding to the target object includes:
directionally sending the prompt information corresponding to the second target option to a second terminal device corresponding to the target object identifier.

The second set of options and the first set of options are represented as circular icons arranged with a specific position as a center.

In another information sending method, a graphical user interface is provided through a terminal device, and the graphical user interface includes a game visual field screen, the method including:
in response to a first touch operation acting on a preset control, determining that an interface focus of the game visual field screen corresponds to a target object of the game scene and displaying a first set of options corresponding to the target object, where the first set of options includes at least one option; where the target object includes at least one of a virtual resource and a virtual scene;
in response to a second touch operation acting on a first target option in the first set of options, determining prompt information corresponding to the first target option, where the first target option is an option in the at least one option;
directionally sending the prompt information corresponding to the first target option to a user terminal corresponding to the target object.

This exemplary embodiment provides an information sending method. Referring to FIG. 3, the information sending method may be applied to a terminal device. The terminal device is used to provide a graphical user interface. The graphical user interface includes a game visual field screen, and the game visual field screen includes at least part of a game scene and at least part of a first virtual object located in the game scene. The terminal device may be the aforementioned local terminal device, or the client device in the aforementioned cloud interaction system. The information sending method may specifically include the following steps S310 to S330. Specifically:

In step S310: in response to a first touch operation acting on a preset control, it is determined that an interface focus of the game visual field screen corresponds to a second virtual object of the game scene, and a first set of options corresponding to the second virtual object is displayed, where the first set of options includes at least one option; where the second virtual object is any virtual object in a virtual object set belonging to a same game side as the first virtual object.

In step S320: in response to a second touch operation acting on a first target option in the first set of options, prompt information corresponding to the first target option is determined, where the first target option is an option in at least one option.

In step S330: the prompt information corresponding to the first target option is directionally sent to a user terminal corresponding to the second virtual object.

By implementing the information sending method shown in FIG. 3, the directional sending of information can be realized, so that it is convenient for players to send information point-to-point in the process of teamwork and improve team communication efficiency. In addition, a set of options can be output for the user to choose, and the user only needs to select one option from the set of options to realize directional information sending to the to-be-sent object without inputting text, which can further improve communication efficiency.

Next, the above-mentioned steps of this exemplary embodiment will be described in more detail.

In step S310, in response to the first touch operation acting on the preset control, it is determined that the interface focus of the game visual field screen corresponds to the second virtual object of the game scene, and the first set of options corresponding to the second virtual object is displayed, where the first set of options includes at least one option; where the second virtual object is any virtual object in the virtual object set belonging to the same game side as the first virtual object.

Specifically, the first touch operation may be a long press operation, a slide operation, a click operation, a gesture operation, or a voice control operation, or any combination of the above operations, which is not limited in the embodiments of the present disclosure. The interface focus may be a crosshair displayed on the user interface in the shooting game, and the place where the crosshair is aligned is the interface focus. The display position of the preset control may be any position in the user interface. Specifically, the second virtual object may be a game player who is different from the first virtual object, and the virtual object set belonging to the same game side as the first virtual object includes one or a plurality of virtual objects, and the second virtual object is any of the plurality of virtual objects.

Optionally, determining that the interface focus of the game visual field screen corresponds to the second virtual object of the game scene includes: determining a trigger time of the preset control, obtaining a game frame corresponding to the trigger time, and determining a crosshair position in the game frame as the interface focus, and then determining that the interface focus of the game visual field screen corresponds to the second virtual object of the game scene.

In step S320, in response to the second touch operation acting on a first target option in the first set of options, prompt information corresponding to the first target option is determined, where the first target option is an option in at least one option.

Among them, each option in the first set of options may be a game instruction, such as “There are enemies around you”, “Follow me”, “Release skills”, “Keep up with the team”, “Wait in place”, “Add friends”, “Go to save someone”, “Get some potion quickly” and so on. Optionally, determining the prompt information corresponding to the target option includes: determining the text content (e.g., Come quickly) in the first target option as the prompt information; or, generating prompt information (for example, Xiao Ming, come quickly) according to the text content (e.g., Come quickly).

Specifically, the second touch operation may be a long press operation, a slide operation, a click operation, a gesture operation, or a voice control operation, or any combination of the above operations, which is not limited in the embodiments of the present disclosure.

In step S330, the prompt information corresponding to the first target option is directionally sent to a user terminal corresponding to the second virtual object.

Optionally, directionally sending the prompt information corresponding to the first target option to the user terminal corresponding to the second virtual object includes: sending the prompt information to a server, so that the server forwards the prompt information to the user terminal corresponding to the second virtual object.

Specifically, the server may be a cloud server. The server forwarding the prompt information to the user terminal corresponding to the second virtual object includes: the server reading a to-be-sent object in the prompt information, and forwarding the prompt information to the user terminal corresponding to the to-be-sent object according to the to-be-sent object. In this way, information can be forwarded through the server, thereby reducing the resource occupation of the local device.

As an optional embodiment, in response to the visual field adjustment instruction, the game visual field screen is controlled to be adjusted from the first game visual field screen to the second game visual field screen according to the visual field adjustment instruction; in response to a third touch operation acting on a preset control, it is determined that an interface focus of the game visual field screen corresponds to a target object of the game scene and a second set of options corresponding to the target object is displayed, where the target object includes at least one of the following: a virtual resource or a virtual scene; in response to a fourth touch operation acting on a second target option in the second set of options, the prompt information corresponding to the second target option is determined; and the prompt information corresponding to the second target option is directionally sent to the user terminal corresponding to the target object.

The second set of options and the first set of options are represented as circular icons arranged with a specific position as a center. In addition, the options in the first set of options and the second set of options may be represented by text, characters, letters, etc., which are not limited in the embodiments of the present disclosure. Different target objects correspond to different sets of options, and one target object may correspond to one or more sets of options. For example, if one target object can correspond to a plurality of sets of options, then, when the first touch operation acting on the preset control is detected and the interface focus corresponds to the target object, the current time can be determined, and the set of options that matches the current time is selected from the plurality of sets of options and is displayed.

Optionally, the fourth touch operation and the third touch operation are continuous operations. Specifically, the fourth touch operation may be an operation of sliding from a different content collection area to the virtual character identification collection area, or the fourth touch operation may include a first sub-operation of first clicking the content collection area and a second sub-operation of then clicking the second virtual character identification area.

Optionally, the above method may further include: receiving a custom option input by the user, determining a set of options selected by the user, adding the above custom option to the set of options to enrich the set of options, increase the scalability of the set of options, and improve interactivity.

Optionally, if the target object is a player, each option in the second set of options is a first type of game instruction, such as “There are enemies around you”, “Follow me”, “Release skills”, “Keep up with the team”, “Wait in place”, “Add friends”, “Go to save someone”, “Get some potion quickly” and so on; if the target object is an item, each option in the second set of options is the player name; if the target object is a scene, then each option in the second set of options is a second type of game instruction, for example, the game instruction may be “Guard this area”, “Please come here for rescue”, “Stay here to attack” and so on.

Optionally, directionally sending the prompt information corresponding to the second target option to the user terminal corresponding to the target object includes: directionally sending the prompt information corresponding to the second target option to the user terminal corresponding to the target object, so that the user terminal displays the prompt information and highlights a map position corresponding to the interface focus when the target object is a virtual resource or a virtual scene.

Specifically, the prompt information includes a player name (for example, Bawanziya) corresponding to the current terminal (i.e., the sending end), and the prompt information may include one or more pieces of information sent by the current terminal. In addition, the user terminal displaying the prompt information and highlighting the map position corresponding to the interface focus when the target object is a virtual resource or a virtual scene, includes: when the target object is a virtual resource, the user terminal displays the prompt information and highlights the position of the virtual resource in the game scene; when the target object is the virtual scene, the user terminal displays the prompt information and highlights the position of the interface focus in the game scene. By highlighting, it is convenient for the user to quickly locate the destination by combining the prompt information and the highlighted position, thereby improving the efficiency of teamwork in the game and improving the user's game experience.

It can be seen that the implementation of this optional embodiment can provide a plurality of directional sending functions. It is possible to select the information first and then select the object to be sent directionally, or it is also possible to first select the object to be sent directionally and then select the information to be sent, thereby improving the interaction diversity.

In an exemplary embodiment of the present disclosure, if the target object is a virtual scene, displaying the second set of options corresponding to the target object includes: displaying a set of content options in the second set of options corresponding to the target object, where the set of content options is a combination of different information that needs to be conveyed to a target second virtual object;
in response to the fourth touch operation acting on the second target option in the second set of options, determining the prompt information corresponding to the second target option includes: in response to a first sub-operation of the fourth touch operation, determining a target content option from the set of content options; in response to determining the target content option, triggering to display a set of second virtual object identifiers in the second set of options; in response to a second sub-operation of the fourth touch operation, determining a target object identifier from the set of virtual object identifiers; determining the corresponding prompt information according to the target object identifier and the target content option.

The target content option may specifically be a second type of game instruction, for example, the game instruction may be “Guard this area”, “Please come here for rescue”, “Stay here to attack” and so on.

It can be seen that the implementation of this optional embodiment can directionally send the prompt information to the designated player, which is beneficial to improve the efficiency of teamwork in the game.

In an exemplary embodiment of the present disclosure, if the target object is a virtual resource, displaying the second set of options corresponding to the target object includes: displaying a set of virtual object identifiers;

in response to the fourth touch operation acting on the second target option in the second set of options, determining the prompt information corresponding to the second target option includes: determining a target object identifier from the set of virtual object identifiers in response to the fourth touch operation; determining the corresponding prompt information according to the target object identifier and the target object.

If the target object is a virtual resource, the target object identifier may be a player name (e.g., a nickname) or a player icon (e.g., an avatar), which is not limited in the embodiments of the present disclosure.

It can be seen that the implementation of this optional embodiment can directionally send the prompt information to the designated player, which is beneficial to improve the efficiency of teamwork in the game.

Optionally, the fourth touch operation and the third touch operation are continuous operations. Specifically, the fourth touch operation may be an operation of sliding from a different content collection area to the virtual character identification collection area, or the fourth touch operation may include a first sub-operation of first clicking the content collection area and a second sub-operation of then clicking the second virtual character identification area.

In an exemplary embodiment of the present disclosure, the second set of options includes a set of virtual object identifiers, and responding to the fourth touch operation acting on the second target option in the second set of options includes: responding to the fourth touch operation acting on the second target option in the second set of options, so as to determine the target object identifier from the set of virtual object identifiers according to the position of the fourth touch operation;
directionally sending the prompt information corresponding to the second target option to the user terminal corresponding to the target object, includes:
directionally sending the prompt information corresponding to the second target option to a second terminal device corresponding to the target object identifier. It can be seen that the implementation of this optional embodiment can provide a plurality of directional sending functions. It is possible to select the information first and then select the object to be directionally sent, or it is possible to select the object to be directionally sent first and then select the information to be sent, so as to improve the interaction diversity.

In an optional embodiment, an information sending method is provided, in which a graphical user interface is provided through a terminal device, and the graphical user interface includes a game visual field screen, the method including:

in response to a first touch operation acting on a preset control, determining that an interface focus of the game visual field screen corresponds to a target object of the game scene and displaying a first set of options corresponding to the target object, where the first set of options includes at least one option; where the target object includes at least one of: a virtual resource or a virtual scene;
in response to a second touch operation acting on a first target option in the first set of options, determining prompt information corresponding to the first target option, where the first target option is an option in the at least one option; and
directionally sending the prompt information corresponding to the first target option to a user terminal corresponding to the target object.

Specifically, the first touch operation may be a long press operation, a slide operation, a click operation, a gesture operation, or a voice control operation, or any combination of the above operations, which is not limited in the embodiments of the present disclosure. The interface focus may be a crosshair displayed on the user interface in the shooting game, and the place where the crosshair is aligned is the interface focus. The display position of the preset control may be any position in the user interface. Specifically, the target object may be a virtual resource or a virtual scene, and there may be a plurality of virtual resources or virtual scenes in the game.

Optionally, determining that the interface focus of the game visual field screen corresponds to the target object of the game scene includes: determining a trigger time of the preset control, acquiring a game frame corresponding to the trigger time, and determining a crosshair position in the game frame as the interface focus, and then determining that the interface focus of the game visual field screen corresponds to the target object of the game scene.

Individual options in the first set of options may be game instructions, for example, “Guard this area”, “Please come here for rescue”, “Stay here to attack” and so on. Optionally, determining the prompt information corresponding to the target option includes:
determining the text content (for example, Guard this area) in the first target option as the prompt information; or generating prompt information (for example, Xiao Ming, you guard this area) according to the text content (for example, Come here soon).

Optionally, directionally sending the prompt information corresponding to the second target option to the user terminal corresponding to the target object includes: directionally sending the prompt information corresponding to the second target option to the user terminal corresponding to the target object, so that the user terminal displays the prompt information and highlights a map position corresponding to the interface focus when the target object is a virtual resource or virtual scene.

Optionally, directionally sending the prompt information corresponding to the first target option to the user terminal corresponding to the second virtual object includes: sending the prompt information to a server, so that the server forwards the prompt information to the user terminal corresponding to the target object.

Specifically, the server may be a cloud server. The server forwarding the prompt information to the user terminal corresponding to the second virtual object includes: the server reading a to-be-sent object in the prompt information, and forwarding the prompt information to the user terminal corresponding to the to-be-sent object according to the to-be-sent object. In this way, information can be forwarded through the server, thereby reducing the resource occupation of the local device.

The first set of options is represented as circular icons arranged with a specific position as a center. In addition, the options in the first set of options may be represented by text, characters, letters, etc., which are not limited in the embodiments of the present disclosure. Different target objects correspond to different sets of options, and one target object may correspond to one or more sets of options. For example, if one target object can correspond to a plurality of sets of options, then, when the first touch operation acting on the preset control is detected and the interface focus corresponds to the target object, the current time can be determined, and a set of options that matches the current time is selected from the plurality of sets of options and is displayed.

Before determining that the interface focus of the game visual field screen corresponds to the target object of the game scene and displaying the second set of options corresponding to the target object, it may also include: in response to a visual field adjustment instruction, controlling the game visual field screen to be adjusted from a first game visual field screen to a second game visual field screen according to the visual field adjustment instruction. Optionally, the first touch operation and the second touch operation are continuous operations. Specifically, the second touch operation may be an operation of sliding from a different content collection area to a virtual character identification collection area, or the second touch operation may include a first sub-operation of first clicking the content collection area and a second sub-operation of then clicking the second virtual character identification area.

Optionally, the above method may further include: receiving a custom option input by the user, determining a set of options selected by the user, adding the above custom option to the set of options to enrich the set of options, increase the scalability of the set of options, and improve interactivity.

Optionally, if the target object is a player, each option in the second set of options is the first type of game instructions, such as “There are enemies around you”, “Follow me”, “Release skills”, “Keep up with the team”, “Wait in place”, “Add friends”, “Go to save someone”, “Get some potion quickly”, etc.; if the target object is an item, each option in the second set of options is the player name; if the target object is a scene, then each option in the second set of options is a second type of game instructions, for example, the game instruction may be “Guard this area”, “Please come here for rescue”, “Stay here to attack” and so on.

Specifically, the prompt information includes a player name (for example, Bawanziya) corresponding to the current terminal (i.e., the sending end), and the prompt information may include one or more pieces of information sent by the current terminal. In addition, the user terminal displaying the prompt information and highlighting the map position corresponding to the interface focus when the target object is a virtual resource or a virtual scene, includes: when the target object is a virtual resource, the user terminal displaying the prompt information and highlighting the position of the virtual resource in the game scene; when the target object is a virtual scene, the user terminal displaying the prompt information and highlighting the position of the interface focus in the game scene. By highlighting, it is convenient for the user to quickly locate the destination by combining the prompt information and the highlighted position, thereby improving the efficiency of teamwork in the game and improving the user's game experience.

By implementing this exemplary method, directional sending of information can be realized, so that it is convenient for players to send information point-to-point in the process of teamwork, and improve the efficiency of team communication. In addition, a set of options can be output for the user to choose, and the user only needs to select one option from the set of options to realize the directional information sending to the to-be-sent object without inputting text, which can further improve communication efficiency.

Further, in this exemplary embodiment, an information sending apparatus is also provided, a graphical user interface is provided through a terminal device, and the graphical user interface includes a game visual field screen, the information sending apparatus including:
an option set output unit, configured to, in response to a first touch operation acting on a preset control, determine that an interface focus of the game visual field screen corresponds to a target object of the game scene, and display a first set of options corresponding to the target object, where the first set of options includes at least one option; where the target object includes at least one of: a virtual resource or a virtual scene;
a prompt information determining unit, configured to, in response to a second touch operation acting on a first target option in the first set of options, determine prompt information corresponding to the first target option, where the first target option is an option in the at least one options;
an information directional sending unit, configured to directionally send the prompt information corresponding to the first target option to a user terminal corresponding to the target object.

By implementing this exemplary apparatus, directional sending of information can be realized, so that it is convenient for players to send information point-to-point in the process of teamwork, and improve the efficiency of team communication. In addition, a set of options can be output for the user to choose, and the user only needs to select one option from the set of options to realize directional information sending to the to-be-sent object without inputting text, which can further improve communication efficiency.

It should be noted that the information processing method in one of the embodiments of the present disclosure can run on a terminal device or a server. The terminal device may be a local terminal device. When the information processing method runs on the server, the information processing method can be implemented and executed based on a cloud interactive system, where the cloud interactive system includes a server and a client device.

In an optional implementation manner, various cloud applications, such as cloud games, can be run under the cloud interactive system. The cloud game is taken as an example, and the cloud game refers to a game manner based on cloud computing. In the operation mode of cloud games, the main body of running the game program and the main body presenting the game screen are separated, the storage and operation of the information processing method are completed on the cloud game server, and the function of the client device is to receive and send data, and present the game screen. For example, the client device may be a display device with data transmission function close to the user side, such as a mobile terminal, TV, computer, palmtop computer, etc.; and the terminal device for information processing is a cloud game server at the cloud side. When playing a game, the player operates the client device to send an operation command to the cloud game server, and the cloud game server runs the game according to the operation command, encodes and compresses the game screen and other data, and returns it to the client device through the network. Finally, the client device decodes it and outputs the game screen.

In an optional implementation manner, the terminal device may be a local terminal device. Taking games as an example, the local terminal device stores game programs and is used to present the game screens. The local terminal device is used to interact with the player through the graphical user interface, that is, conventionally, the electronic device downloads and installs the game program and runs it. The local terminal device may provide the graphical user interface to the player in various manners, for example, rendering and displaying it on the display screen of the terminal, or providing it to the player through holographic projection. For example, the local terminal device may include a display screen and a processor, the display screen is used to present a graphical user interface, the graphical user interface includes a game screen, and the processor is used to run the game, generate a graphical user interface, and control the graphical user interface to be displayed on the display.

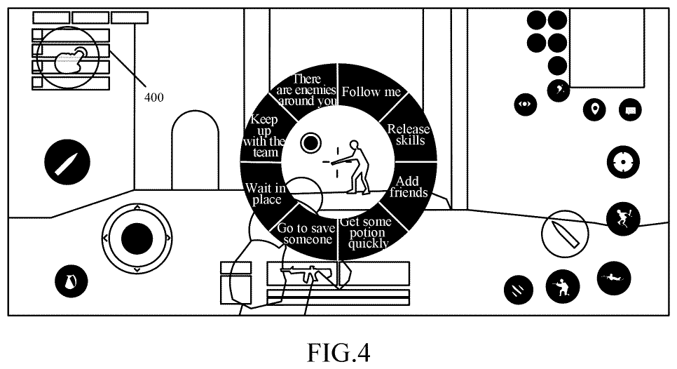

FIG. 4 is referred to, which schematically shows a schematic diagram of an interface including a first set of options according to an embodiment of the present disclosure. As shown in FIG. 4, in the game, when a touch operation acting on a specified player 400 in the player list is detected, a set of options including a first target option may be output, and a first type of game instructions included in each option in the set of options are respectively: “Follow me”, “Release skills”, “Add friends”, “Get some potion quickly”, “Go to save someone”, “Wait in place”, “Keep up with the team”. When a second touch operation acting on the first target option (for example, “Wait in place”) in the first set of options is detected, prompt information (for example, Xiao Ming, please wait in place) corresponding to the first target option can be determined, and the prompt information is sent to a user terminal corresponding to the designated player 400, and the user terminal is a terminal corresponding to the designated player 400.

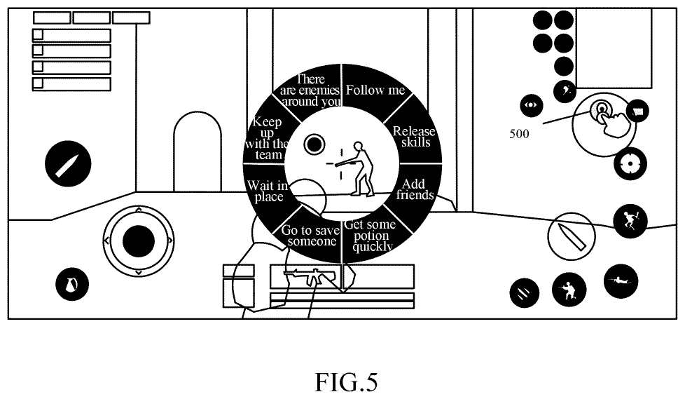

FIG. 5 is referred to, which schematically shows a schematic diagram of an interface including a first set of options according to an embodiment of the present disclosure. As shown in FIG. 5, when a first touch operation acting on a preset control 500 is detected, an interface focus when the preset control 500 is triggered can be determined. If the interface focus corresponds to a first virtual object (that is, a player), then a set of options corresponding to the player is displayed; where the set of options corresponding to each player may be the same or different. Specifically, the first type of game instructions included in each option in the set of options are respectively: “Follow me”, “Release skills”, “Add friends”, “Get some potion quickly”, “Go to save someone”, “Wait in place”, “keep up with the team”. When a second touch operation acting on the first target option (for example, “Add friends”) in the set of options is detected, the prompt information (for example, Xiao Ming, let's add friends) corresponding to the first target option can be determined, and the prompt information is sent to a user terminal of the player.

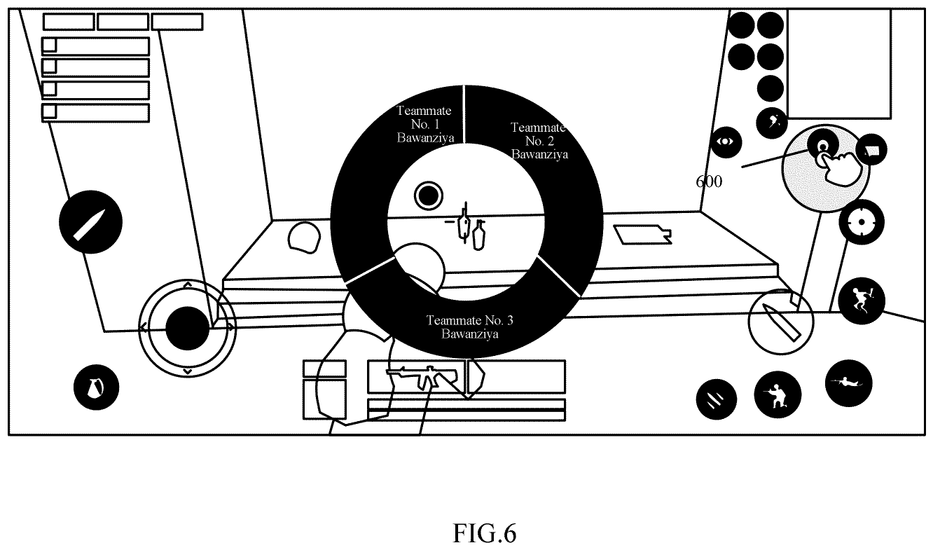

FIG. 6 is referred to, which schematically shows a schematic diagram of an interface including a second set of options according to an embodiment of the present disclosure. As shown in FIG. 6, when a third touch operation acting on a preset control 600 is detected, an interface focus when the preset control 600 is triggered can be determined, and if the target object corresponding to the interface focus is an item, a second set of options corresponding to the item (e.g., medicine) is displayed; where the second set of options corresponding to each item may be the same or different. Specifically, the player names included in each option in the second set of options are: “Teammate No. 1 Bawanziya”, “Teammate No. 2 Bawanziya”, and “Teammate No. 3 Bawanziya”. When a second touch operation acting on a second target option (for example, Teammate No. 2 Bawanziya) in the set of options is detected, prompt information (for example, “Teammate No. 2, come here to get the medicine) corresponding to the second target option can be determined, and the prompt information is sent to the user terminal corresponding to the second target option.

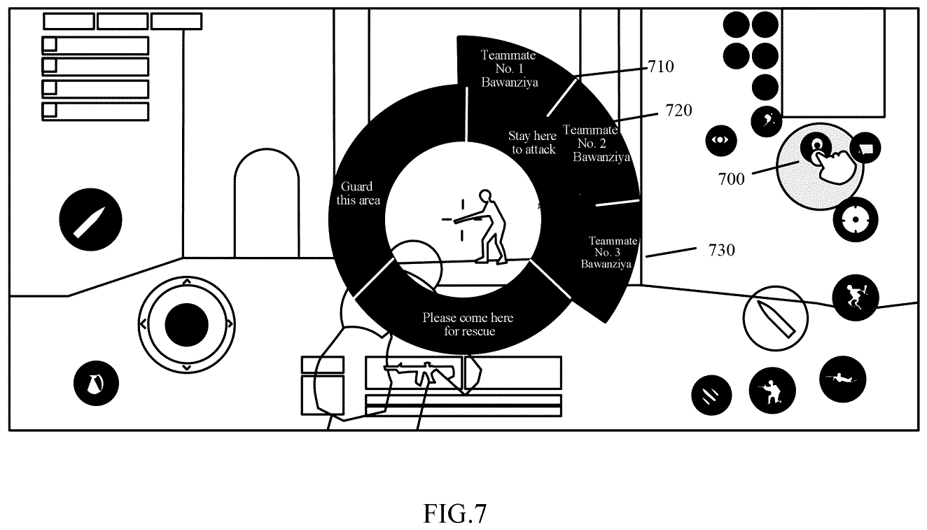

FIG. 7 is referred to, which schematically shows a schematic diagram of a display interface including a second set of options according to an embodiment of the present disclosure. As shown in FIG. 7, when a first touch operation acting on a preset control 700 is detected, an interface focus when the preset control 700 is triggered can be determined. If the target object corresponding to the interface focus is a scene, a set of options corresponding to that scene is displayed. The set of options corresponding to each scene may be the same or different. Specifically, the second type of game instructions contained in each option in the set of options are: “Guard this area”, “Stay here to attack”, “Please come here for rescue”. When a second touch operation acting on a target option (for example, “Guard this area”) in the set of options is detected, a set of players corresponding to the second target option is output: “Teammate No. 1 Bawanziya” 710, “Teammate No. 2 Bawanziya” 720, “Teammate No. 3 Bawanziya” 730. When a touch operation acting on a target player (such as “Teammate No. 3 Bawanziya” 730) in the set of players is detected, a user terminal corresponding to the target player is determined; and the prompt information (for example, “Teammate No. 3 Bawanziya, you guard this area”) corresponding to the target option is sent to a user terminal corresponding to the target player.

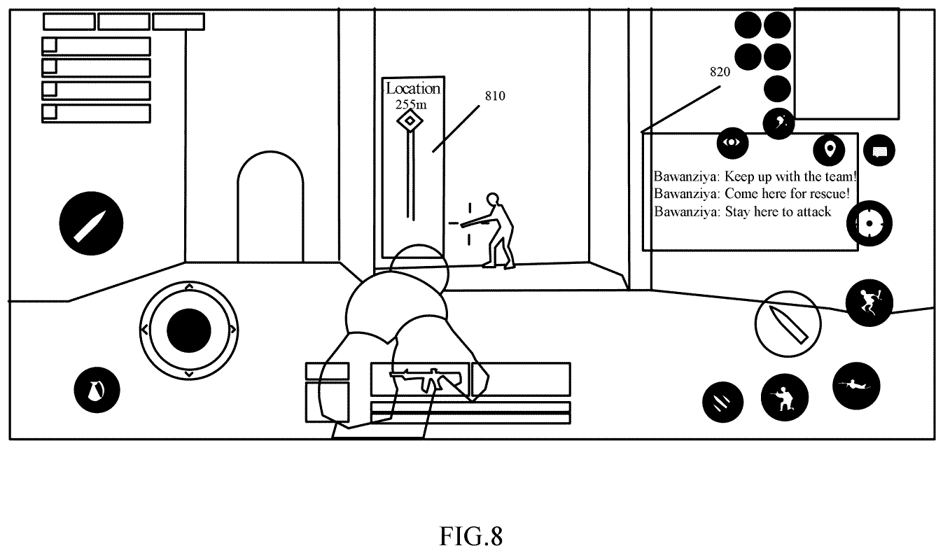

FIG. 8 is referred to, which schematically shows an interface for displaying prompt information on a user terminal according to an embodiment of the present disclosure. As shown in FIG. 8, after other user terminal sends the prompt information to the corresponding current terminal, the current terminal may display the prompt information 820. The prompt information 820 specifically includes “Bawanziya: Keep up with the team? Bawanziya: Come here for rescue! Bawanziya: Stay here to attack”. Since the target object is a scene, a map position 810 corresponding to the interface focus can be highlighted in the display interface of the current terminal, so that the player corresponding to the current terminal can quickly locate the position that needs to be attacked, and the team tactical benefit in the game is improved, which is convenient for the players to use their own experience to assist team members in combat. It should be noted that, the display position of the prompt information 820 in the user interface may be any position, FIG. 8 is only a schematic illustration, and the embodiments of the present disclosure do not limit the display position.

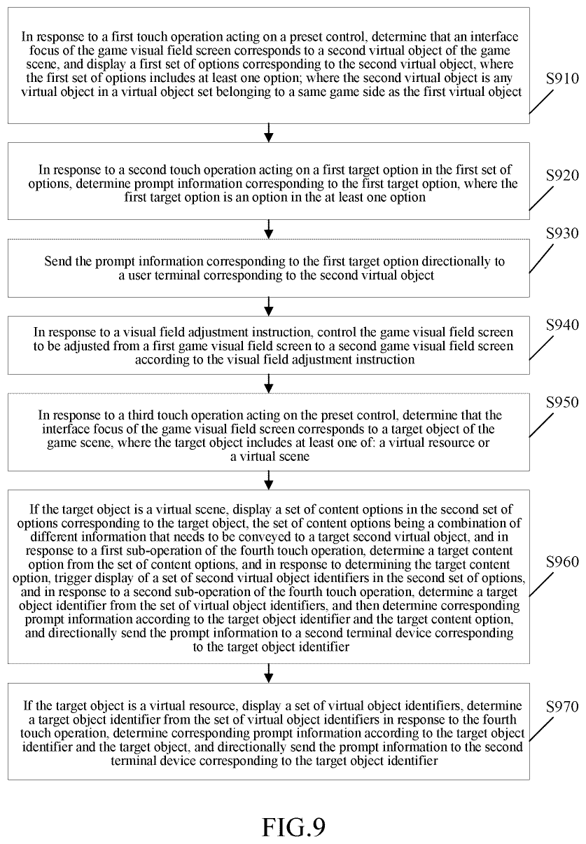

FIG. 9 is referred to, which schematically shows a flowchart of an information sending method according to an embodiment of the present disclosure. As shown in FIG. 9, the information sending method includes: step S910 to step S970.

In step S910: in response to a first touch operation acting on a preset control, it is determined that an interface focus of the game visual field screen corresponds to a second virtual object of the game scene, and a first set of options corresponding to the second virtual object is displayed, where the first set of options includes at least one option; where the second virtual object is any virtual object in a virtual object set belonging to a same game side as the first virtual object.

In step S920: in response to a second touch operation acting on a first target option in the first set of options, prompt information corresponding to the first target option is determined, where the first target option is an option in the at least one option.

In step S930: the prompt information corresponding to the first target option is directionally sent to a user terminal corresponding to the second virtual object. In step S940: in response to a visual field adjustment instruction, the game visual field screen is controlled to be adjusted from a first game visual field screen to a second game visual field screen according to the visual field adjustment instruction.

In step S950: in response to a third touch operation acting on the preset control, it is determined that the interface focus of the game visual field screen corresponds to a target object of the game scene, where the target object includes at least one of: a virtual resource or a virtual scene.

In step S960: if the target object is a virtual scene, a set of content options in the second set of options corresponding to the target object is displayed, the set of content options being a combination of different information that needs to be conveyed to a target second virtual object, and in response to a first sub-operation of the fourth touch operation, a target content option is determined from the set of content options, and in response to determining the target content option, display of a set of second virtual object identifiers in the second set of options is triggered, and in response to a second sub-operation of the fourth touch operation, a target object identifier is determined from the set of virtual object identifiers, and then corresponding prompt information is determined according to the target object identifier and the target content option, and the prompt information is directionally sent to a second terminal device corresponding to the target object identifier.

In step S970: if the target object is a virtual resource, a set of virtual object identifiers is displayed, a target object identifier is determined from the set of virtual object identifiers in response to the fourth touch operation, corresponding prompt information is determined according to the target object identifier and the target object, and the prompt information is directionally sent to the second terminal device corresponding to the target object identifier.

It should be noted that steps S910 to S970 correspond to the steps and their embodiments shown in FIG. 3. For the specific implementation manner of steps S910 to S970, the steps and their embodiments shown in FIG. 3 may be referred to, which are not elaborated here.

It can be seen that implementing the information sending method shown in FIG. 9 can realize directional sending of information, thereby making it convenient for players to send information point-to-point in the process of teamwork and improving team communication efficiency. In addition, a set of options can be output for the user to choose, and the user only needs to select one option from the set of options to realize directional information sending to the to-be-sent object without inputting text, which can further improve communication efficiency.

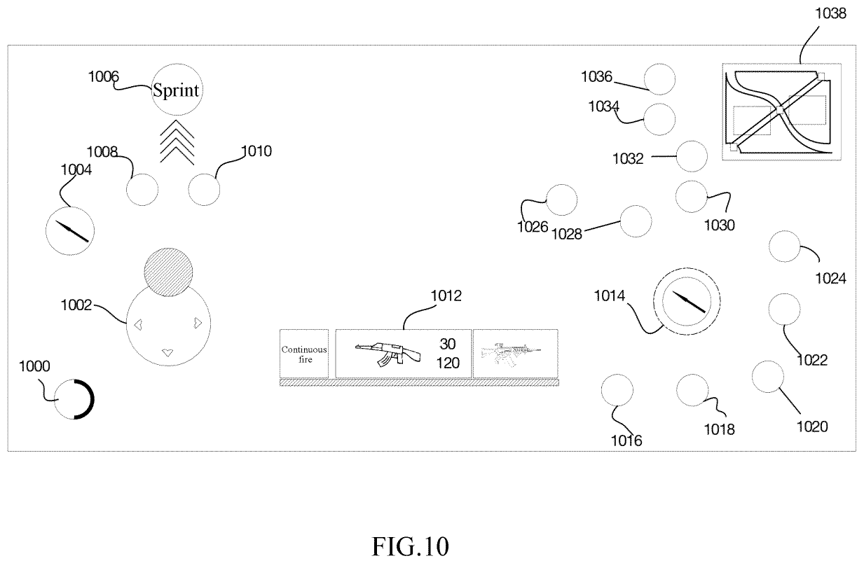

An application scenario of this embodiment is provided below. A schematic diagram of a graphical user interface is shown in FIG. 10. The interface includes a game scene and virtual objects located in the game scene, and the game scene and virtual objects are not shown in FIG. 10. The player controls the first virtual object to move in the game scene. The interface in FIG. 10 shows various controls, which are displayed on the game scene.

Among them, 1000 is a backpack control. Through the touch operation acting on this control, display of a backpack interface in the graphical user interface is triggered to view the items and props in the backpack. The items and props may include but not limited to: medicines, weapons, accessories, armors, and other props. In an optional implementation manner, an edge line is provided on the edge of the backpack control to indicate the amount of items in the backpack. The touch operation acting on the backpack control may be operations such as click, double click, long press, and slide.

1002 is a movement control, and a circle filled with shadows is a joystick in the movement control. In an optional implementation manner, the movement control is configured with a movement response area, where the movement response area may be the same size as the movement control, that is, the area in the graphical user interface corresponding to the movement control is the movement response area. In an optional implementation manner, the size of the movement response area may be larger than the size of the movement control, that is, the movement control is set in the movement response area. In particular, the graphical user interface is divided into left and right areas from the middle, where the left area is the movement response area of the movement control. The movement control instruction is triggered by the touch operation acting on the movement response area of the movement control, and the moving direction of the virtual object is controlled according to the movement control instruction. The touch operations acting on the movement response area of the movement control may be operations such as click, double click, long press, and slide.

When it is detected that the touch operation that triggers the movement control instruction satisfies a preset condition, a “Sprint” instruction is triggered to control the virtual object to automatically and continuously run in the game scene. As shown in FIG. 5, in an optional implementation manner, the touch operation that triggers the movement control instruction meeting the preset condition is that the touch operation acting on the joystick area slides a preset distance or slides to a preset area along a preset direction (e.g., the position indicated by an arrow above the joystick). For example, when the joystick is dragged upwards by the touch operation, a sprint control 1006 appears, and when the sprint control is triggered, the virtual object enters a fast running mode. At the same time, the control 1030 is also a sprint control, and when the control 1030 is clicked, the virtual object enters a fast running mode. In an optional implementation manner, the touch operation that triggers the movement control instruction meeting the preset condition is that the touch operation acting on the joystick area satisfies a preset duration, or satisfies a preset pressure.

1004 and 1014 are both attack controls, and an attack instruction is triggered by a touch operation acting on an attack response area of the attack control, and the virtual character is controlled to perform an attack operation in the game scene according to the attack instruction. The attack behavior triggered by the attack control corresponds to the current assembly state of the virtual object. For example, when the virtual object is equipped with a long-range weapon, the attack behavior triggered by the attack control is a shooting behavior, that is, the left hand can perform the shooting operation by triggering the control 1004, and the right hand can perform the shooting operation by triggering the control 1014; when the virtual character is equipped with a melee weapon, the attack behavior triggered by the attack control is a slashing behavior, etc. In an optional implementation manner, only one of the attack control 1004 and the attack control 1014 is displayed. The display position of the attack control may be adjusted according to a position setting instruction, where the position setting instruction may be triggered when setting the interface, or may be triggered during the game. The touch operation acting on the attack control may be operations such as click, double-click, long-press, and slide.

1008 and 1010 are posture controls, and a posture adjustment instruction is triggered through a touch operation acting on the posture controls, so as to adjust the posture of the virtual object in the game scene. Among them, triggering the control 1008 can control the weapon to be located on the left arm of the virtual object, and control the virtual object to stand with the posture of turning the head to the left; triggering the control 1010 can control the weapon to be located on the right arm of the virtual object, and control the virtual object to stand with the posture of turning the head to the right. 1008 and 1010 are mostly used for posture control of the virtual object when the virtual object is avoiding obstacles such as walls and trees. The touch operation acting on the posture controls may be operations such as click, double click, long press, and slide.

1012 is a weapon slot, and triggering the weapon slot can switch the weapon used by the player. The “Continuous fire” on the left is used to indicate the current shooting mode. In the “Continuous fire” mode, multiple bullets are fired continuously. In addition to the “Continuous fire” mode, it can also be switched to the “Single shot” mode, and in the “Single shot” mode, a single bullet is fired. The lower shaded bar is used to show the amount of bullets in the weapon. When shooting, the amount of bullets keeps decreasing. When the amount of bullets becomes zero, the bullets can be changed automatically, and then the amount of bullets is at the maximum. In addition, the control 1016 is a reloading control, triggering the reloading control can add bullets to the currently used weapon, and after reloading, the amount of bullets is the maximum. The touch operation acting on the weapon slot may be operations such as click, double click, long press, and slide.

Controls 1018 and 1020 are motion controls, and the virtual objects are controlled to perform corresponding actions in the game scene through touch operations acting on the motion controls. For example, triggering 1018 can control the virtual object to squat, and triggering 1020 can control the virtual object to prostrate on the ground. The control 1022 can control the virtual object to perform a jumping action. The touch operation acting on the action control may be operations such as click, double-click, long-press, and slide.

Control 1024 is used to control the current game scene to enter the scope mode. When the first touch operation acting on the control 1024 is detected, it is controlled to enter the scope mode. In the scope mode, the aiming lens is displayed in the game scene, and the game scene seen by the virtual object through the aiming lens is also displayed. In the scope mode, the accuracy of shooting can be improved. When the second touch operation acting on the control 1024 is detected, it is controlled to exit the scope mode. In an optional implementation manner, the first touch operation and the second touch operation are independent touch operations. For example, by clicking the control 1024, the current game scene is controlled to enter the scope mode, and by clicking the control 1024 again, the scope mode is exited, and a game scene captured by a virtual camera following a virtual object is displayed again. In an optional implementation manner, the first touch operation and the second touch operation may be a start operation and end operation of one touch operation, for example, when touching the control 1024 is detected, the game scene is controlled to enter the scope mode, during the continuous pressing process, the game scene is controlled to be in the scope mode continuously, and when it is detected that a touch medium that triggers the touch operation leaves the touch detection area, it is controlled to exit the scope mode.

Control 1026 is used to control the shooting parameters of the virtual camera presenting the game screen, thereby adjusting the visual field screen of the game scene displayed in the graphical user interface. In an optional implementation manner, it is determined that a touch operation acting on the control 1026 is detected, and the shooting parameters of the virtual camera are adjusted according to the touch operation, where the shooting parameters include but not limited to a position, an orientation, a viewing angle, etc. of the virtual camera. The touch operation acting on the control 1026 may be operations such as click, double-click, long-press, and slide.

The control 1028 is a marking control, and the virtual objects, virtual substances, etc. in the game scene are marked through touch operations acting on the marking control. Control 1032 is a setting control, by clicking on the control 1032, a setting menu is displayed, so as to set the basic functions of the current game. The touch operations acting on the control 1028 may be operations such as click, double-click, long-press, and slide.

Controls 1034 and 1036 are message controls, where 1034 can be used to view system notifications, and 1036 can be used to view messages sent by teammates, or send messages to teammates. 1038 is a small map, which is used to display the position of the virtual object controlled by the player, and may also display the positions of virtual objects of some other players.

Based on the above application scenarios, the player can trigger the execution of the information sending method in this embodiment by triggering a preset control.

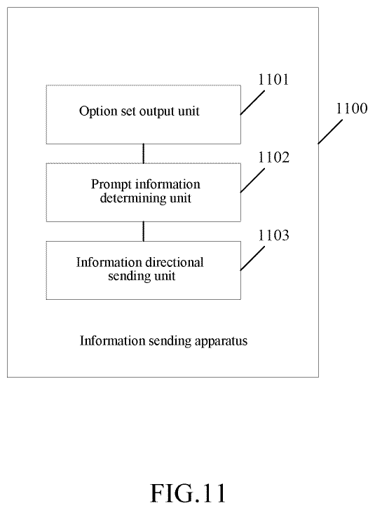

Further, in this exemplary embodiment, an information sending apparatus is also provided. Referring to FIG. 11, the information sending apparatus 1100 may include:
an option set output unit 1101, configured to, in response to a first touch operation acting on a preset control, determine that an interface focus of the game visual field screen corresponds to a second virtual object of the game scene, and display a first set of options corresponding to the second virtual object, where the first set of options includes at least one option; where the second virtual object is any virtual object in a virtual object set belonging to a same game side as the first virtual object;
a prompt information determining unit 1102, configured to, in response to a second touch operation acting on a first target option in the first set of options, determine prompt information corresponding to the first target option, where the first target option is an option in the at least one options; and
an information directional sending unit 1103, configured to directionally send the prompt information corresponding to the first target option to a user terminal corresponding to the second virtual object.

It can be seen that implementing the apparatus shown in FIG. 11 can realize directional sending of information, so that it is convenient for players to send information point-to-point in the process of teamwork and improve the efficiency of team communication. In addition, a set of options can be output for the user to choose, and the user only needs to select one option from the set of options to realize directional information sending to the to-be-sent object without inputting text, which can further improve communication efficiency.

In an exemplary embodiment of the present disclosure, the above-mentioned apparatus further includes:
a visual field screen adjustment unit, configured to, in response to a visual field adjustment instruction, control the game visual field screen to be adjusted from a first game visual field screen to a second game visual field screen according to the visual field adjustment instruction;
the option set output unit 1101 is further configured to, in response to a third touch operation acting on the preset control, determine that the interface focus of the game visual field screen corresponds to a target object of the game scene, and display a second set of options corresponding to the target object, where the target object includes at least one of a virtual resource or a virtual scene;
the prompt information determining unit 1102 is further configured to, in response to a fourth touch operation acting on a second target option in the second set of options, determine prompt information corresponding to the second target option;
the information directional sending unit 1103 is further configured to directionally send the prompt information corresponding to the second target option to a user terminal corresponding to the target object.

The second set of options and the first set of options are represented as circular icons arranged with a specific position as a center.

It can be seen that the implementation of this optional embodiment can provide many directional sending functions. It is possible to select the information first and then select the object to be directionally sent, or it is possible to select the object to be directionally sent first and then select the information to be sent, thereby improving the interaction diversity.

In an exemplary embodiment of the present disclosure, if the target object is a virtual scene, the option set output unit 1101 displaying a second set of options corresponding to the target object, includes:
displaying a set of content options in the second set of options corresponding to the target object, where the set of content options is a combination of different information that needs to be conveyed to a target second virtual object;
the prompt information determining unit 1102 determining the prompt information corresponding to the second target option in response to the fourth touch operation acting on the second target option in the second set of options, includes:
in response to a first sub-operation of the fourth touch operation, determining a target content option from the set of content options;
in response to determining the target content option, triggering display of a set of second virtual object identifiers in the second set of options;
in response to a second sub-operation of the fourth touch operation, determining a target object identifier from the set of virtual object identifiers;
determining corresponding prompt information according to the target object identifier and the target content option.

It can be seen that the implementation of this optional embodiment can send prompt information to designated players, which is beneficial to improve the efficiency of teamwork in the game.

In an exemplary embodiment of the present disclosure, if the target object is a virtual resource, the option set output unit 1101 displaying a second set of options corresponding to the target object, includes:
displaying a set of virtual object identifiers;
the prompt information determining unit 1102 determining the prompt information corresponding to the second target option in response to the fourth touch operation acting on the second target option in the second set of options, includes:
in response to the fourth touch operation, determining a target object identifier from the set of virtual object identifiers;
determining corresponding prompt information according to the target object identifier and the target object.

It can be seen that the implementation of this optional embodiment can send prompt information to designated players, which is beneficial to improve the efficiency of teamwork in the game.

In an exemplary embodiment of the present disclosure, the second set of options includes a set of virtual object identifiers, and in response to the fourth touch operation acting on the second target option in the second set of options, the prompt information determining unit 1102 is configured to:
in response to the fourth touch operation acting on the second target option in the second set of options, determine a target object identifier from the set of virtual object identifiers according to a position of the fourth touch operation; and the information directional sending unit 1103 directionally sending the prompt information corresponding to the second target option to the user terminal corresponding to the target object, includes:
directionally sending the prompt information corresponding to the second target option to a second terminal device corresponding to the target object identifier.

It can be seen that the implementation of this optional embodiment can provide many directional sending functions. It is possible to select the information first and then select the object to be directionally sent, or it is possible to select the object to be directionally sent first and then select the information to be sent, so as to improve the interaction diversity.

It should be noted that although several modules or units of the device for action execution are mentioned in the above detailed description, this division is not mandatory. Actually, according to the implementation manners of the present disclosure, the features and functions of two or more modules or units described above may be embodied in one module or unit. Conversely, the features and functions of one module or unit described above can be further divided to be embodied by a plurality of modules or units.

Since each functional module of the information sending apparatus in the exemplary embodiments of the present disclosure corresponds to the steps of the exemplary embodiments of the above-mentioned information sending method, for the details not disclosed in the apparatus embodiments of the present disclosure, the above-mentioned embodiments of information sending method of the present disclosure may be referred to.

Other embodiments of the present disclosure will be readily apparent to those skilled in the art from consideration of the specification and practice of the contents disclosed herein. The present disclosure is intended to cover any modification, use or adaptation of the present disclosure. These modifications, uses or adaptations follow the general principles of the present disclosure and include common knowledge or habitual technical means in the present technical field that are not disclosed in the present disclosure. The specification and embodiments are to be considered exemplary only, with a true scope and spirit of the present disclosure being indicated by the appended claims.

It should be understood that the present disclosure is not limited to the precise constructions which have been described above and shown in the drawings, and various modifications and changes may be made without departing from the scope thereof. The scope of the present disclosure is limited only by the appended claims.

1. An information sending method, wherein a graphical user interface is provided through a terminal device, the graphical user interface comprises a game visual field screen, and the game visual field screen comprises at least part of a game scene and at least part of a first virtual object located in the game scene, the method comprises:
in response to a first touch operation acting on a preset control, determining, by the terminal device, that an interface focus of the game visual field screen corresponds to a second virtual object of the game scene, and displaying a first set of options corresponding to the second virtual object, wherein the first set of options comprises at least one option: wherein the second virtual object is any virtual object in a virtual object set belonging to a same game side as the first virtual object;
in response to a second touch operation acting on a first target option in the first set of options, determining, by the terminal device, prompt information corresponding to the first target option, wherein the first target option is one of the at least one option in the first set of options; and
directionally sending, by the terminal device, the prompt information corresponding to the first target option to a user terminal corresponding to the second virtual object.

2. The method according to claim 1, wherein the method further comprises:
in response to a visual field adjustment instruction, controlling the game visual field screen to be adjusted from a first game visual field screen to a second game visual field screen according to the visual field adjustment instruction;
in response to a third touch operation acting on the preset control, determining that the interface focus of the game visual field screen corresponds to a target object of the game scene, and displaying a second set of options corresponding to the target object, wherein the second set of options comprises at least one option, wherein the target object comprises at least one of a virtual resource or a virtual scene;
in response to a fourth touch operation acting on a second target option in the second set of options, determining prompt information corresponding to the second target option, wherein the second target option is one of the at least one option in the second set of options; and
directionally sending the prompt information corresponding to the second target option to a user terminal corresponding to the target object.

3. The method according to claim 2, wherein in a case that the target object is the virtual scene, displaying the second set of options corresponding to the target object comprises:
displaying a set of content options in the second set of options corresponding to the target object, wherein the set of content options is a combination of different information that needs to be conveyed to a target second virtual object;
in response to the fourth touch operation acting on the second target option in the second set of options, determining the prompt information corresponding to the second target option comprises:
in response to a first sub-operation of the fourth touch operation, determining a target content option from the set of content options;
in response to determining the target content option, triggering display of displaying a set of second virtual object identifiers in the second set of options;
in response to a second sub-operation of the fourth touch operation, determining a target object identifier from the set of second virtual object identifiers;
determining corresponding prompt information according to the target object identifier and the target content option.

4. The method according to claim 2, wherein in a case that the target object is the virtual resource, displaying the second set of options corresponding to the target object comprises:
displaying a set of virtual object identifiers; and
wherein in response to the fourth touch operation acting on the second target option in the second set of options, determining the prompt information corresponding to the second target option comprises:
in response to the fourth touch operation, determining a target object identifier from the set of virtual object identifiers;
determining corresponding prompt information according to the target object identifier and the target object.

5. The method according to claim 2, wherein the second set of options comprises a set of virtual object identifiers, and wherein in response to the fourth touch operation acting on the second target option in the second set of options comprises:
in response to the fourth touch operation acting on the second target option in the second set of options, determining a target object identifier from the set of virtual object identifiers according to a position of the fourth touch operation; and
wherein directionally sending the prompt information corresponding to the second target option to the user terminal corresponding to the target object comprises:
directionally sending the prompt information corresponding to the second target option to a second terminal device corresponding to the target object identifier.

6. The method according to claim 2, wherein the second set of options and the first set of options comprise icons arranged in a circular shape with a specific center position.

7. An information sending method, wherein a graphical user interface is provided through a terminal device, and the graphical user interface comprises a game visual field screen, the method comprises:
in response to a first touch operation acting on a preset control, determining, by the terminal device, that an interface focus of the game visual field screen corresponds to a target object of a game scene, and displaying a first set of options corresponding to the target object, wherein the first set of options comprises at least one option: wherein the target object comprises at least one of a virtual resource or a virtual scene;
in response to a second touch operation acting on a first target option in the first set of options, determining, by the terminal device, prompt information corresponding to the first target option, wherein the first target option is one of in the at least one option in the first set of options; and
directionally sending, by the terminal device, the prompt information corresponding to the first target option to a user terminal corresponding to the target object.

8. (canceled)

9. A non-transitory computer-readable storage medium having stored thereon instruction that, when executed by a processor of an electronic device, cause the electronic device to perform operations of a control method, the control method comprising:
in response to a first touch operation acting on a preset control, determining that an interface focus of the game visual field screen corresponds to a second virtual object of the game scene, and displaying a first set of options corresponding to the second virtual object, wherein the first set of options comprises at least one option; wherein the second virtual object is any virtual object in a virtual object set belonging to a same game side as the first virtual object;
in response to a second touch operation acting on a first target option in the first set of options, determining prompt information corresponding to the first target option, wherein the first target option is one of the at least one option in the first set of options; and
directionally sending the prompt information corresponding to the first target option to a user terminal corresponding to the second virtual object.

10. An electronic device, wherein a graphical user interface is provided through a terminal device, the graphical user interface comprises a game visual field screen, and the game visual field screen comprises at least part of a game scene and at least part of a first virtual object located in the game scene, the electronic device comprising:
one or more processors; and
a storage apparatus, configured to store one or more programs, wherein when the one or more programs are executed by the one or more processors, the one or more processors are enabled to implement the information sending method according to claim 1.

11. The method according to claim 1, wherein determining, by the terminal device, that the interface focus of the game visual field screen corresponds to the second virtual object of the game scene comprises:
determining a trigger time of the preset control, obtaining a game frame corresponding to the trigger time, determining a crosshair position in the game frame as the interface focus, and then determining that the interface focus of the game visual field screen corresponds to the second virtual object of the game scene.

12. The method according to claim 1, wherein directionally sending, by the terminal device, the prompt information corresponding to the first target option to the user terminal corresponding to the second virtual object comprises:
sending the prompt information to a server, so that the server forwards the prompt information to the user terminal corresponding to the second virtual object.

13. The method according to claim 1, wherein the server forwards the prompt information to the user terminal corresponding to the second virtual object comprises:
the server reading a to-be-sent object in the prompt information, and forwarding the prompt information to the user terminal corresponding to the to-be-sent object according to the to-be-sent object.

14. The method according to claim 1, further comprising:
receiving a custom option input by a user, determining a set of options selected by the user, and adding the custom option to the set of options.

15. The method according to claim 2, wherein the fourth touch operation and the third touch operation are continuous operations.

16. The method according to claim 1, wherein the first touch operation and the second touch operation are any one of or any combination of a long press operation, a slide operation, a click operation, a gesture operation, a voice control operation.

17. The electronic device according to claim 9, wherein the processor is further configured to:
in response to a visual field adjustment instruction, control the game visual field screen to be adjusted from a first game visual field screen to a second game visual field screen according to the visual field adjustment instruction;
in response to a third touch operation acting on the preset control, determine that the interface focus of the game visual field screen corresponds to a target object of the game scene, and display a second set of options corresponding to the target object, wherein the second set of options comprises at least one option, wherein the target object comprises at least one of a virtual resource or a virtual scene;
in response to a fourth touch operation acting on a second target option in the second set of options, determine prompt information corresponding to the second target option, wherein the second target option is one of the at least one option in the second set of options; and
directionally send the prompt information corresponding to the second target option to a user terminal corresponding to the target object.

18. The electronic device according to claim 10, wherein in a case that the target object is the virtual scene, the processor is further configured to:
display a set of content options in the second set of options corresponding to the target object, wherein the set of content options is a combination of different information that needs to be conveyed to a target second virtual object;
in response to the fourth touch operation acting on the second target option in the second set of options, determine the prompt information corresponding to the second target option comprises:
in response to a first sub-operation of the fourth touch operation, determine a target content option from the set of content options;
in response to determining the target content option, displaying a set of second virtual object identifiers in the second set of options;
in response to a second sub-operation of the fourth touch operation, determine a target object identifier from the set of second virtual object identifiers;
determine corresponding prompt information according to the target object identifier and the target content option.

19. The electronic device according to claim 10, wherein in a case that the target object is the virtual resource, the processor is further configured to:
display a set of virtual object identifiers; and
in response to the fourth touch operation acting on the second target option in the second set of options, determine the prompt information corresponding to the second target option, comprises:
in response to the fourth touch operation, determine a target object identifier from the set of virtual object identifiers;
determine corresponding prompt information according to the target object identifier and the target object.

20. The electronic device according to claim 10, wherein the second set of options comprises a set of virtual object identifiers, and the processor is further configured to:
in response to the fourth touch operation acting on the second target option in the second set of options, determine a target object identifier from the set of virtual object identifiers according to a position of the fourth touch operation; and
directionally send the prompt information corresponding to the second target option to a second terminal device corresponding to the target object identifier.

21. The electronic device according to claim 10, wherein the second set of options and the first set of options comprise icons arranged in a circular shape with a specific center position.
